(19) United States
(12) Patent Application Publication
(10) Pub. No.: US 2026/0015819 A1
(43) Pub. Date: Jan. 15, 2026

(54) WORK MACHINE INTERFACE FOR SELECTING A WORK LEVEL OF WORK MACHINE

(71) Applicant: Caterpillar Inc., Peoria, IL (US)

(72) Inventors: Mo Wei, Dunlap, IL (US); Xinyu Ge, Peoria, IL (US)

(73) Assignee: Caterpillar Inc., Peoria, IL (US)

(21) Appl. No.: 18/768,814

(22) Filed: Jul. 10, 2024

(51) Int. Cl. E02F 3/43; E02F 3/32; E02F 9/26

(52) U.S. Cl. CPC E02F 3/437; E02F 3/32; E02F 9/262

(57) ABSTRACT

A work machine may include a machine frame supported on a traction system, an implement supported by the machine frame and operable to perform work, an electrical power supply system configured for powering the traction system and the implement, and an electronic controller configured for controlling operation of the work machine and for calculating an accumulated damage score for a plurality of work cycles. The electronic controller may include a human-machine interface comprising a push level selector allowing an operator to select a push level to be used to perform the plurality of work cycles. The electronic controller may be configured to select a factor based on the selected push level to be used to calculate the accumulated damage score.

### TECHNICAL FIELD

The present application relates generally to an electrical power system for a work machine. More particularly, the present application relates to a power management system for the electrical power system of the work machine. Still more particularly, the present application relates to a user interface that allows a user to select between one or more power outputs based on several types of information.

### BACKGROUND

Work machines such as earthmoving machines or other material handling machines may consume various amounts of power depending on the environment and conditions in which they work. Power consumption may also depend on the type of operations being performed by the work machine and on the rate the operations are performed. For example, the power consumption of an excavator may depend on the type of material being excavated as well as its moisture content, consistency, uniformity, temperature, etc. That is, where the ground is frozen, or even cold, as compared to warm, the amount of energy used to excavate may generally be greater. Still further, the aggressiveness of the digging operations and the speed of digging operations can affect the amount of power consumed. In some cases, while aggressive digging operations can consume power more quickly, they can also cause degradation of the electrical system such as a battery power supply where currents are overly high, for example.

In some cases, operators of work machines may generally work with a mindset of completing work as fast as they can or within the timeframe allowed to them within a given workday or work session. These efforts may be performed without regard to how much energy is being consumed or how quickly the work machine is being degraded. In these circumstances, work machines may have a tendency to over-consume power followed by time periods of non-use, which may be inefficient. In other cases, where an operator is given excessive amounts of time to complete a task, the available power may be underutilized. U.S. Pat. No. 11,248,365 relates to automated control for excavators where methods and systems relate to operating an excavator during a digging cycle are described. A nominal path of a bucket on an excavator may be commanded. A correction to the commanded nominal path may be applied to maximize a power applied by at least one of the one or more linkages of the excavator during at least a portion of the digging cycle.

### SUMMARY

In one or more examples, a work machine may include a machine frame supported on a traction system, an implement supported by the machine frame and operable to perform work, an electrical power supply system configured for powering the traction system and the implement, and an electronic controller configured for controlling operation of the work machine and for calculating an accumulated damage score for a plurality of work cycles. The electronic controller may include a human-machine interface comprising a push level selector allowing an operator to select a push level to be used to perform the plurality of work cycles. The electronic controller may be configured to select a factor based on the selected push level to be used to calculate the accumulated damage score.

In another example, a method of operating a work machine may include selecting a first push level on a human-machine interface, calculating a first accumulated damage function of a first plurality of work cycles for the first push level, selecting a second push level on the human-machine interface, and calculating a second accumulated damage function of a second plurality of work cycles for the second push level. The method may also include comparing the first accumulated damage function to the second accumulated damage function and selecting a push level for a project based on the comparing and based on a project constraint.

### BRIEF DESCRIPTION OF THE DRAWINGS

FIG. 1 is a side elevational view of an example of a work machine in the form of a hydraulic excavator adapted for material moving operations, according to one or more examples.

FIG. 2 is a diagram of a human-machine interface for inputting site information.

FIG. 3 is a diagram of a human-machine interface for monitoring, managing, and controlling operations of the work machine.

FIG. 4A is a schematic diagram depicting a side view of a work cycle of the hydraulic excavator of FIG. 1, according to one or more examples.

FIG. 4B is a schematic diagram depicting a top down view of the work cycle of the hydraulic excavator of FIG. 1, according to one or more embodiments.

FIG. 5 is a diagram depicting a method of operation of a work machine, according to one or more examples.

### DETAILED DESCRIPTION

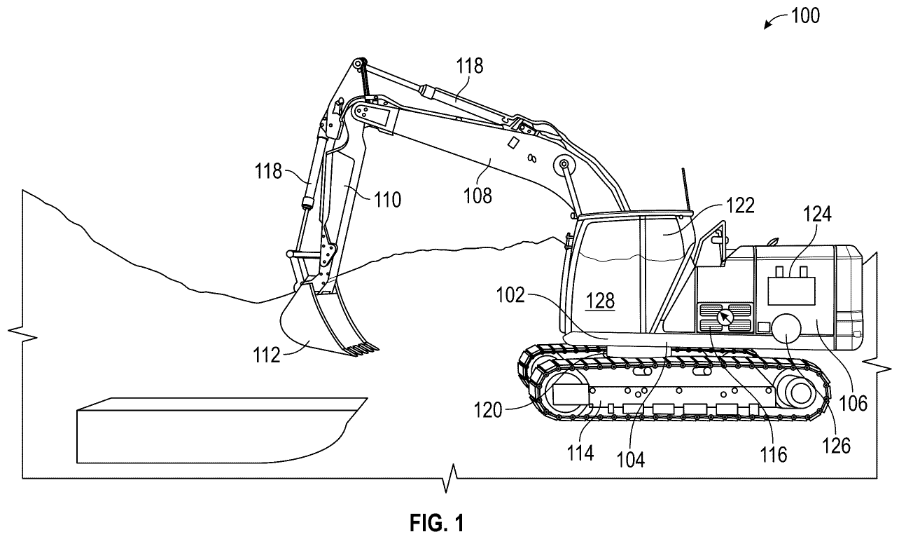

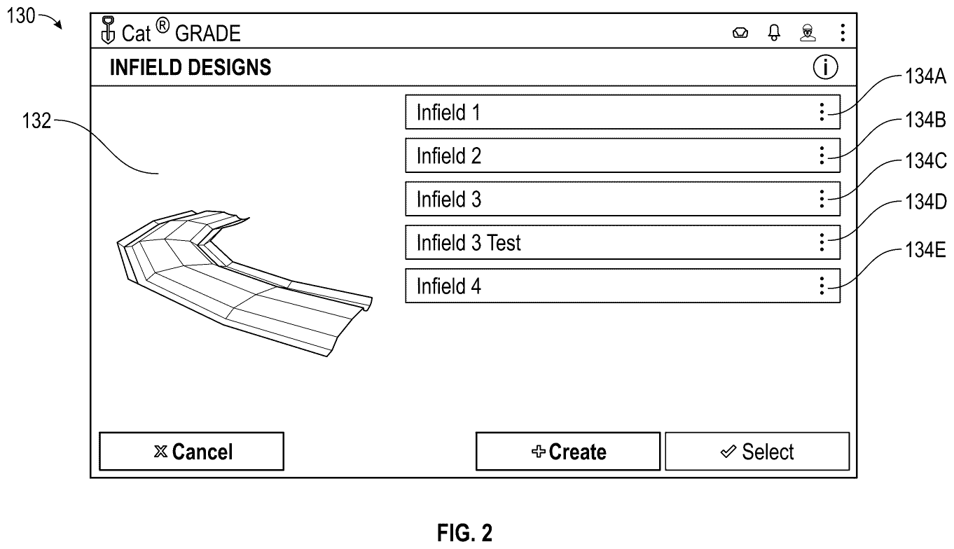

FIG. 1 is a perspective view of a work machine 100 in the form of an excavator. The work machine 100 may include a support frame 102 including a rotating platform 104 and a prime mover 106 arranged on the platform 104 in addition to a cab or operator station 122. The work machine 100 may also include a primary boom 108 extending from the rotary platform, a secondary boom 110 extending from the primary boom 108, and a bucket 112 or other implement arranged on an end of the secondary boom 110. The work machine 100 may also include a ground engaging traction system such as a track system 114. Still further, the work machine may include a power monitoring/management system and associated human-machine interfaces allowing for selections of machine output as well as estimating power consumption and/or battery degradation. Still other features of the work machine 100 may be provided. Moreover, while an excavator has been provided as an example, still other types of work machines 100 may be provided. For example, a work machine 100 may include a paver, crawler, front-end loader, compactor, rotary mixer, cold planer, haul truck, or another type of work machine 100 may be provided. The present system may be particularly useful with work machines where work cycles and/or relatively consistent and repeating work machine output may be identified for use in estimating power consumption and battery damage for a task or project.

The work machine 100 may include a hydraulic system 116 operably coupled to the prime mover 106 to provide power to the hydraulic system 116. In one or more examples, the hydraulic system 116 may be used to operate one or more implements on the work machine 100. For example, with the excavator shown, the hydraulic system 116 may be used to drive, or retract, hydraulic cylinders 118 to pivot the primary and secondary booms 108/110 and/or the bucket 112 and to rotate the rotary platform 104. In the case of other work machines 100, other implements may be operated using a hydraulic system 116.

As mentioned, the work machine 100 can include a rotary platform 104, which can swing the boom/bucket system with respect to the terrain surface. For example, the machine frame 102 may include an undercarriage 120 that is associated with the traction/propulsion devices and the platform 104 that is situated above the undercarriage 120. The undercarriage 120 and the platform 104 may be coupled by a swing drive motor and a ring gear that rotate the boom/bucket system to different locations over the terrain surface during a terrain moving operation.

To operate the work machine 100, the platform 102 can include an onboard operator station 122 or operators cab to accommodate an operator. The work machine 100 can also be configured for autonomous, semi-autonomous, and/or remote operation. In autonomous operation, the work machine 100 may utilize various sensors and controls to conduct operations without human interaction. In semi-autonomous operation, a human operator may conduct some of the tasks and assume some control over the work machine 100, while the machine itself may be responsible for other operations. In remote configurations, the operator may be located off-board and away from the work machine 100 and may control it through a remote-control system. Combinations of remote-control and semi-autonomous operation may also be provided.

The work machine 100 can utilize an electrical power source to power operation of the machine. To provide the electrical power, a power plant in the form of a primary power source 124 can be disposed on the machine frame 102. The primary power source 124 can be the primary driver of the traction system 114 for mobility of the work machine 100 with respect to the terrain surface. The primary power source 124 can also be electrically connected with a pump motor 126 which supplies rotational power to the hydraulic system 116 and can also power the swing drive motor to swing the platform 104. Other features of the work machine 100 may also be powered by the primary power source 124.

To generate electric power for the work machine 100, the primary power source 124 can be embodied as any suitable source of electrical energy to provide and supply electrical power in the form of electrical current and voltage to a load. The primary power source 124 can produce electrical power as either direct current or alternating current, and the alternating electrical current can be single phase or polyphase electricity. The primary power source 124 can produce electrical power utilizing any suitable technology and operating principle include electromagnetic, thermodynamic, chemical, solar, etc.

The primary power source 124 can be, for example, a battery pack comprised of a plurality of electro-chemical battery cells that function as an energy storage system for electricity. The battery pack can store and supply direct current electricity and the individual battery cells that can be secondary rechargeable cells cable of being periodically charged, discharged, and recharged. The individual electrochemical cells can be assembled in modules, and the modules can be structurally assembled together as a battery pack for facilitating electrical connectivity and mounting to the machine frame 102. In other embodiments, the primary power source 124 can be a fuel cell that converts the chemical energy of a fuel such as hydrogen into electrical energy. In yet another example, the power source 124 can be an electrical generator that is coupled to the output shaft of the internal combustion engine to receive motive power in the form of rotational torque. A generator converts motive power embodied as rotational motion into electrical power in the form of alternating electrical current that can be converted to direct current using a power converter.

In one or more examples, an electronic controller 128 can be included and disposed on the work machine 100. The electronic controller 128 can include various circuitry components in any suitable computer architecture for receiving and processing data and software to operate. The electronic controller 128 can process and execute different functions, steps, routines, and instructions written as computer readable software programs and may use data from sources such as data tables, charts, data maps, lookup tables and the like. Additionally, the electronic controller 128 can be responsible for processing functions associated with various other systems on the work machine 100. While the electronic controller 128 is illustrated as a standalone device, its functions may be distributed among a plurality of distinct and separate components. In one or more examples, the electronic controller may be part of an electronic control module (ECM) that is used to control operations or the work machine 100.

In one or more examples, the electronic controller 128 can include one or more microprocessors such as a central processing unit (CPU), an application specific integrated circuit (ASIC), or a field programmable gate array (FPGA) comprising a plurality of transistors and similar circuits that are capable of reading, manipulating and outputting data in electronic form. The electronic controller 128 can include non-transient programmable memory or other data storage capabilities such as random access memory or more permanent non-volatile forms of data storage media. Common examples of computer-readable memory include RAM, PROM, and EPROM, a FLASH-EPROM, and any other memory chip or cartridge. The memory is capable of storing in software form the programming instructions and the data that can be read and processed by the microprocessor. The software and data may take the form of instruction sets, programs, applications, routines, libraries, databases, lookup tables, data sets, and the like. To communicate with other instruments and actuators associated with and electrically connected to the power bus, the electronic controller 128 can include various input/output cards and related circuitry. Communication may be established by sending and receiving digital or analog signals across electronic communication lines or communication busses using any suitable data communication protocols, including wireless protocols.

In an embodiment, to interface with an operator of the work machine 100, the electronic controller 128 can be operatively associated with and communicate with one or more operator interface devices. For example, to receive operator commands to maneuver the traction system 114 and the booms during operation, an operator input device such as a joystick can be included onboard in the operator station 122 or off-board for remote control. During a terrain moving work cycle, the joystick can be pivoted in multiple directions, and the movements of the joystick triggered by an operator are converted to electronic signals to the electronic controller 128 that adjust operation of the hydraulic system 116 to lift, lower, extend and/or retract the booms with respect to the terrain surface. In addition to the joystick, other examples of input devices for maneuvering may include steering wheels, gear sticks, and the like.

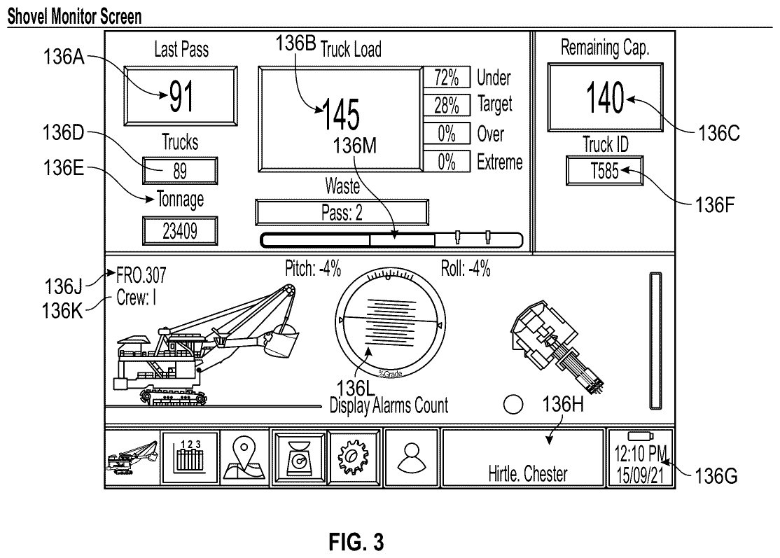

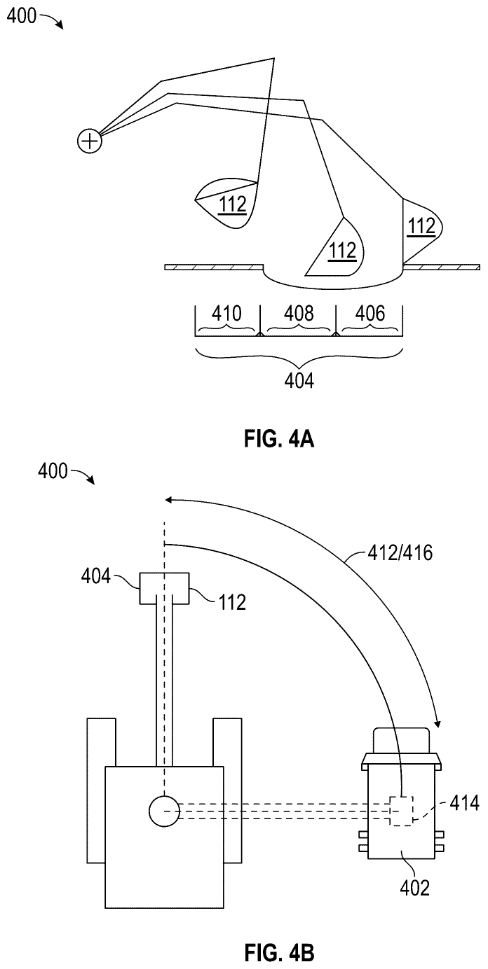

To further interface with the operator, as shown in FIGS. 3 and 4, a display device with one or more human-machine interfaces (HMI) 130 can be included. The HMI 130 can include visual display screen 132 such as an LCD screen that may have touch screen capabilities. Information regarding operation of the work machine 100 can be visually presented on the visual display screen 132 for the operator such as the operating speed of various systems, operational settings like gear selection, and the relative position and location of various structures like the booms and the angular position of the platform 104. To receive operational settings, the HMI 130 may also include tactile inputs like buttons, keys, dials, etc. Tactile inputs can also be located on the joystick.

As shown in FIG. 3, the electronic controller 128 may be configured to display a human-machine interface particularly adapted for capturing site information from a user. For purposes of assessing the power consumption and/or effect on battery life of the work machine, site information may be captured for a project or task site. In one or more examples, as shown, the HMI may include input fields for one or more aspects of a project or task site. That is, the HMI may include an input field for the site dimensions. This may include an area value 134A such as the square footage of the project site to be excavated. Site dimensions may also include the excavation depth 134B such that, and together with the area value 134A, the total material volume to be excavated may be determined. The HMI may also include an input field 134C for material characteristics. In one or more examples this may include a soil type, a wetness factor, or other inputs relevant to the material to be excavated. The HMI may also include an environmental temperature value 134D, which may be relevant for understanding or calculating power consumption for heating or cooling and/or battery wear/life relating to overly hot or overly cold temperatures. The HMI may also include an input field 134E for frozen layer depth. That is, for example, in winter conditions, where a top portion of the work site is frozen, the depth of frozen material may be provided by the operator to assist with understanding the power consumption and effect on battery life of excavating at that location. It is to be appreciated that one or more of the above values relating to material type, frozen depth, etc. may be obtained from soil borings or a soil report that may commonly be obtained prior to the start of a construction project. Still further input fields may be provided.

Turning now to FIG. 3, the electronic controller 128 may be configured to display a human-machine interface particularly adapted for planning, managing, and/or performing excavation tasks. As shown, the HMI may include information relating to excavation amounts and truck loading. For example, the HMI may include a last pass field 136A showing the tonnage of material from a particular bucket load, a truck load 136B showing the tonnage of material currently loaded in a truck, and a remaining capacity 136C showing the tonnage that can still be loaded onto the truck. In addition, a truck count 136D and tonnage since shift change 136E may also displayed and a truck identification 136F may also be displayed for the truck currently being loaded. In one or more examples a date, time, and battery status 136G may be displayed as well as an operator name 136H, a shovel/bucket identification 136J and a shift name 136K. A pad grade indicator 136L may be provided showing the pitch and roll of the pad as evidenced by the pitch and roll of the work machine 100. Of particular relevance to the present application, the HMI may also include a target load indicator 136M showing the push level of the machine during the current excavation pass. This value may be selectable by the operator and may be useful to manage the effort put forth by the work machine 100 such that the operator may manage battery usage and/or battery life. In one or more examples, as described in more detail below, the operator may set the push level during one or more trial runs to help assess the effect on the work machine and, thus, to allow for strategic planning with respect to the rate of excavation. Alternatively, or additionally, the push level indicator 136M may display the push level being used by an autodig process, for example. In one or more examples, the push level may have discrete values such as extreme, very strong, strong, economic, and saving. In other examples, a sliding scale from 0-10, 0-100, or other sliding scale may be provided. Moreover, while a push level indicator 136M has been shown and described, alternatively or additionally, a percentage of bucket load may be provided. As may be appreciated, these values may correlate because when a higher push level is provided, a larger amount of material may be collected by the excavator bucket. As such, in one or more examples, the HMI may include a push level indicator 136M, a percent bucket load indicator, or both.

The electronic controller 128 may also be configured to estimate power/battery usage and/or battery damage based on a variety of factors and based on a particular work cycle. For example, and as discussed in more detail below with respect to FIGS. 4A and 4B, a particular work cycle of a work machine such as an excavator may include a dig-stroke segment 404, a loaded swing segment 412, a dump segment 414, and an unloaded swing segment 416. Each of these aspects of the work cycle may be associated with distinguishable amounts of power consumption and/or load on the electrical supply system. For example, the dig-stroke segment 404 may require substantial power to cause the leading edge of the bucket 112 to penetrate and move through the terrain surface compared with the swing and dump segments 412, 414, 416. In particular, penetration and displacement of the terrain surface with the bucket 112 through movable articulation with the booms requires the hydraulic system 116 to produce and apply substantial hydraulic pressures to the hydraulic actuators. The pump motor therefore must draw electrical power in a proportionally substantial quantity from the primary power source 124. Furthermore, the electrical power requirements, or load, across an individual cycle segment may also vary. For example, referring to FIG. 4A, during the break-in sub-segment 406 of the dig-stroke segment 404, the forces required may relatively large to drive the leading edge of the bucket 112 into and fracture the terrain surface. By contrast, once the leading edge has penetrated a sufficient depth into the terrain surface, the force requirements to move the bucket 112 through the material during the dig-in sub-segment 408 may lessen or abate. The power consumption of each segment and the work cycle as a whole may be estimated based on a variety of factors. The electronic controller may include instruction sets, programs, applications, routines, libraries, databases, lookup tables, data sets, and the like that are particularly adapted for estimating the power consumption of the work cycle based on input from the operator via the human-machine interface to allow the operator, project manager, or other controlling or managing personnel to make decisions about how aggressively, non-aggressively, to operate the work machine given particular circumstances.

To facilitate estimating the power consumption and/or load/damage on the electrical system or battery throughout the work cycle, the electronic controller 128 may be configured to actively monitor and respond to the work cycle 400 conducted by the work machine 100. That is, for example, trial cycles may be performed to inform the electronic controller 128 with power consumption rates current rates or values for one or more portions of the work cycle. That is, the electronic controller 128 can be programmed to receive, process, and analyze information about the operations and activities of the work machine 100 that may be provided by a plurality of sensors. A sensor can be capable of sensing and/or measuring a physical condition or changing condition of the work machine or a characteristic of the surrounding environment and communicating that information to the electronic controller 128 as electronic data signals. The sensors can work upon any suitable operating principle for the assigned task, and may make mechanical, electrical, visual, and/or chemical measurements.

For example, to measure the state of charge of the primary power source 124, which quantifies the available capacity at a given time, a primary power sensor can be operatively associated therewith. In an embodiment, the primary power sensor can be a voltage sensor that is connected across the positive and negative terminals of the primary power source 124 to determine the voltage potential. The measured voltage potential can be converted to the current state of charge of the primary power source 124 using known equations. The primary power sensor can also be configured to measure additional electrical parameters associated with the primary power source 124. For example, the primary power sensor 340 may also measure power or current flow to or from the primary power source 124 using a coulomb counting method.

To sense the position and actions of the booms or bucket, one or more linkage sensors can be associated therewith. For example, to determine the position and locational arrangement of the boom or booms 108/110, rotary encoders can be attached to the joints along the boom. The rotary encoders can measure the relative angular displacement between the booms 108/110. Using dimensional data associated with the booms and kinematic equations that may be saved in the memory of the electronic controller 128, the relative position and movement of the bucket 112 with respect to the terrain surface can be determined.

Alternatively or additionally, the linkage sensors may be fluid pressure sensors operatively associated with the hydraulic actuators attached to the booms 108/110. The fluid pressure sensors can measure the hydraulic fluid pressure in the hydraulic actuators, which may be indicative of the forces and strains applied to the booms and may be proportional to the power requirements of the hydraulic system 116. The fluid pressure in the hydraulic actuators can also be indicative of the extension and retraction of the actuators, which, through dimensional data and kinematic equations, can be converted to determine the spatial motion and positions of the booms 108/110.

To measure other operational conditions and activities of the work machine 100, motor sensors can be associated with the various electric motors, including the pump motor 126, the traction motor, and the swing drive motor, driving movement of the machine 100. The motor sensors can measure various outputs and values of the electric motors such as angular movement, rotational speed, and torque. Data from the motor sensors can reflect the current activities of the work machine 100, and thus the electrical power requirements. Examples of motor sensors include Hall Effect sensors, inductive sensors, optical sensors, and virtual sensors configured to indirectly compute motor output from different parameter measurements.

The power requirement of the work machine 100 may be related and influenced by the conditions and characteristics of the material and terrain being moved. Material data can therefore be obtained by one or more material sensors associated with the work machine 100. The material sensors can assess qualities and values associated with terrain surface like material density or weight, material hardness, temperature, moisture content, etc. The material sensors can concurrently collect the material data during operation of the work machine 100, for example, simultaneously with the work cycle. Material data may also be collected by the material sensors in advance of the work cycle and can be maintained as data stored in the memory of the electronic controller 128. As mentioned, material data may also be input by the user. In still other examples, material information may be both input by a user and collected with sensors of the work machine. For example, while soil information may be available before excavation takes place, moisture contents may change and/or other site conditions may change due to weather and the like, where a material sensor may be useful for collecting material information and managing changing conditions.

To enable the electronic controller 128 to analyze processes and compute values responsive to the work cycle, computer readable data related to the power requirements corresponding to the different cycle segments can be maintained in a power requirements database. The data in the power requirements database can be predetermined by design or obtained by empirical testing and can stored in the form of lookup tables, graphs, or power curves. Data values obtained from the various sensors associated with the work machine 100 can be referenced to the power requirements database to assess or estimate the electrical power requirements during the different cycle segments.

Information about the work cycles can be stored in and obtained from a work cycle database that is associated with the electronic controller 128. The information and data included in work cycle database can reflect operating procedures and settings associated with the work cycle, for example, the instructions and actions for sequentially conducting the dig-stroke, swing, and dump segments of the work cycle. The work cycle database can include sequence timings and duration, range and speed settings for angular and linear motions, and other information necessary for conducting the work cycle. Because the work cycle data and settings may be time dependent, a digital counter or clock for timing can be associated with the work cycle database.

Where the cycle segments and work cycle are repetitive and sequential, the data and information in the work cycle database can be organized in instruction sets for automatically conducting a complete work cycle. For example, during autonomous operation of the work machine 100, the electronic controller 128 can read the instruction set including the necessary instructions and commands for sequentially executing the cycle segment of the work cycle and consequentially direct powered operation of the electrical motors to induce movement in accordance with the work cycle. The instruction set may also include settings and instructions for the electronic controller to facilitate distribution of electrical power during the work cycles.

### INDUSTRIAL APPLICABILITY

Primary power source 124 can be responsible for electrically powering the work machine 100 through a series of operations and maneuvers to conduct a work-related task, which may be referred to as a work cycle. As may be common in large scale work operations, the work cycle may be repeated several times to accomplish the desired result. For example, referring to FIGS. 4A and 4B, an excavator type work machine may have a typical work cycle 400 can be an excavation cycle or terrain moving work cycle to move earthen materials and terrain from one location to another location, for example, a haul truck 402. The work cycle 400 may be partitioned into a series of distinct sequential operations and maneuvers conducted in a continuous, repeated pattern. The work cycle 400 including the plurality of sequential cycle segments can be conducted manually by operator control of the work machine, semi autonomously, or fully autonomously. In one or more examples, a fully autonomous operation may include an autodig process where the work machine may provide for a series of work cycles to be performed by the work machine without operator intervention.

To load the haul truck 402, the work cycle 400 can be begin with a dig-stroke segment 204 in which the bucket 104 or similarly terrain moving tool is moved adjacent to the plane of the terrain surface at the worksite by manipulation of the tool linkage 110. At the beginning of the dig-stroke segment 204, the leading edge of the bucket 104 may be in abutting contact with the plane of the terrain surface 102. The dig-stroke segment 204 may also be divided into a plurality of sub-segments. For example, referring to FIG. 4A, the booms 108/110 are hydraulically powered to vertically drive the leading edge of the bucket 114 into and penetrate the terrain surface, which may be referred to as the penetration or break-in sub-segment 406. The break-in sub-segment 406 can be characterized by relatively large forces to initiate penetration of the terrain surface and, thus, reflecting generation of a large quantity of power by the work machine for operating the booms/bucket.

The dig-stroke segment 204 can continue by moving the bucket along and vertically into the terrain surface toward the work machine 100 thereby filling the bucket with material in what can be referred to as a dig-in sub-segment 408. Once the bucket is moved proximate to the work machine 100 and the dig-in sub-segment 208 is compete, the bucket may be vertically lifted from the terrain surface to remove the excavated material in what can be referred to as loaded lift sub-segment 410. The bucket can also be angularly curled with respect to the booms 108/110 to better situate the material therein.

When the bucket is filled with the material, the work cycle 400 can include a loaded swing segment 412 to maneuver the bucket from the location of the dig-stroke segment 404 toward the haul truck 402. Referring to FIG. 4B, during the loaded swing segment 412, the platform 104 may be rotated with respect to the undercarriage 120 about the vertical axis of the work machine 100 by the swing machinery. When the bucket is positioned over the haul truck 402 (indicated in dashed lines) the work cycle 400 can include a dump segment 414 in which the bucket is pivoted with respect to the booms 108/110 to release the material therein. After the bucket has been emptied to the haul truck 402, the work cycle 400 includes an empty swing segment 416 in which the platform 104 rotates the booms 108/110 and bucket again with respect to the terrain surface to position the bucket for the next dig-stroke segment 404.

With this type of repetitive work cycle various parameters may be used to estimate the power consumption and/or battery usage/damage of the work machine when performing the work cycle. In one or more examples, the power consumption and/or battery usage/accumulated damage may depend on the total digging material volume, which can be estimated by considering how full the bucket is on each cycle of the work cycle compared to the overall bucket volume as well as the number of work cycles. The following equation may show the relationship between several relevant values:

$$( Number of Work Cycles ) \times ( Percentage Bucket Load ) \times ( Bucket Volume ) = ( Total Material Volume ) .$$

As mentioned above, the HMI may be used to collect site dimensions such that a Total Material Volume may be calculated or determined. Moreover, work machine specifications may include the bucket volume. These values may be constant given a particular task/project. However, both the number of work cycles and the percentage bucket load may vary and/or be intentionally varied to manage load/wear on the work machine. For example, if the work cycle takes a particular period of time and the task is desired to be completed within a particular amount of time, the time may be divided by the work cycle period to determine how many cycles there is time for. Using the number of work cycles, the percentage bucket load can be calculated. Conversely, if the percentage of bucket load is known or selected, the number or work cycles may be determined, which may, in turn, be used to determine the total amount of time required for the task or project. This may be compared to project schedules or other time constraints relevant to a task or project.

Of the variables mentioned, the percentage bucket load may directly affect how hard the work machine is working and, thus, may directly affect the power consumption by the work machine. Moreover, the fullness of the bucket may dictate how hard the work machine has to work to penetrate the ground during the break-in sub-segment 406 of the work cycle. In some examples, this may be deemed a “push level” or target load which reflects how hard the work machine works to break-in during the break-in sub-segment, and thus, affects the percentage bucket load. In addition to percentage bucket load or push level, the length of time over which the work machine is operating is also relevant to the power consumption. Still further, the material and its condition may also affect how much power is consumed throughout the task or project, how fast that power is consumed, and what conditions the battery or electrical power system is subject to during operation.

In one or more examples, an accumulated damage function may be used to assess performance of a particular task or project. That is, an accumulated damage function may be used to make decisions about how to operate a work machine given the available amount of time to complete a project and the desire to manage power consumption as well as wear and tear on the electrical system and, in particular, the battery. In one or more examples, an accumulated damage function may be used to calculate an accumulated damage score and may include:

$$( Score ) = ( Material Factor ) \times ( Total Hours ) \times ( Push Level Factor )$$

The push level can be a selected value by the operator and can be inputted using the human-machine interface described. That is, as shown in FIG. 3, the push level may be displayed on the HMI and may also be selectable by the user. This inputted value may be used with a lookup table to establish the Push Level Factor. That is, depending on the push level, a table may be provided that provides a series of push level factors that depend on the amount of time the machine is being continuously operated and, for example, the depth of frozen ground. In one or more examples, a different table may be provided for the various push levels such as extreme, very strong, strong, economic, or saving. Still other numbers of tables may be provided based on the various push level selections available on the HMI.

| | | Continuous Running Hours | | | | | | | |
|---|---|---|---|---|---|---|---|---|---|
| | | 5 | 10 | 15 | 20 | 25 | 30 | 35 | 40 |
| Frozen | 0 | 1 | 1 | 1 | 1 | 1 | 1.2 | 1.3 | 1.5 |
| Depthe | 50 | 1 | 1 | 1 | 1 | 1 | 1.2 | 1.3 | 1.5 |
| (mm) | 100 | 1 | 1 | 1 | 1 | 1 | 1.2 | 1.3 | 1.5 |
| | 150 | 1 | 1. | 1 | 1 | 1 | 1.2 | 1.3 | 1.5 |
| | 200 | 1 | 1 | 1 | 1 | 1 | 1.2 | 1.3 | 1.5 |
| | 250 | 1.2 | 1.25 | 1.3 | 1.35 | 1.4 | 1.45 | 1.5 | 1.55 |
| | 300 | 1.2 | 1.25 | 1.3 | 1.35 | 1.4 | 1.45 | 1.5 | 1.55 |
| | 350 | 1.35 | 1.4 | 1.45 | 1.5 | 1.55 | 1.6 | 1.65 | 1.7 |
| | 400 | 1.35 | 1.4 | 1.45 | 1.5 | 1.55 | 1.6 | 1.65 | 1.7 |
| | 450 | 1.35 | 1.4 | 1.45 | 1.5 | 1.55 | 1.6 | 1.65 | 1.7 |
| | 500 | 1.45 | 1.5 | 1.55 | 1.6 | 1.65 | 1.7 | 1.75 | 1.8 |
| | 600 | 1.45 | 1.5 | 1.55 | 1.6 | 1.65 | 1.7 | 1.75 | 1.8 |
| | 700 | 1.5 | 1.55 | 1.6 | 1.65 | 1.7 | 1.75 | 1.8 | 1.85 |
| | 1000 | 1.5 | 1.55 | 1.6 | 1.65 | 1.7 | 1.75 | 1.8 | 1.85 |

In addition, the total hours can be determined from the above-referenced equation based on the details of the site and a relationship between push level and percentage bucket volume. In some examples, the operator may perform trial runs to establish a relationship between push level and percentage bucket volume. That is, for example, if the push level is set to very strong, this may normally correlate, for example with an approximately 80% full bucket. However, if during trial runs, it shows that this push level only provides a 65 or 75% full bucket, the number of cycles may be adjusted to coincide with the bucket fullness actually occurring based on the push level. In one or more examples, the material factor may be available through a lookup table as well.

In view of the above, the human-machine interface on the work machine may be used to manage how hard the work machine is worked based on one or more parameters. That is, there may be particular time constraints on completing a task or project or, in other situations, there may be no time constraints or the available amount of time may be relatively high. In either case, the work machine may be configured to estimate an accumulated damage function allowing a user to find a balance between how hard to work the work machine and completing a task or project on time.

As an example, a winter project may involve excavating 8100 yd³ of material. Where 100% full bucket loads are used (e.g., an “extreme” push level is selected by the operator) and based on a bucket volume of 1.62 yd³ of a particular excavator, 5000 work cycles may be used to excavate all of the material. Based on considerations relating to the project including travel time of the work machine and/or other factors, a work cycle time of 20 seconds may be used. In one or more examples, one or more trial runs may be used to determine the work cycle time. In either case, once the work cycle time is determined, the total project time can be determined. In this example, the total project time can be calculated as 100,000 seconds or approximately 28 hours.

If we assume that the operator may work 10-hour days, for example, the continuous running time of the work machine may be approximately 10 hours and where the frozen depth of ground is, for example, 350-450 mm, the pushing level factor may be 1.4. Moreover, if we assume the material factor to be 1.0, then the accumulated damage score may be calculated. In this example, the accumulated damage score may be:

$$Accumulated Damage Score = 1. \times 28 \times 1.4 = 39.2 .$$

Where the operator or contractor has more time available to complete the task, the operator may select a lower push level in an effort to minimize damage to the battery and prolong the useful life of the system. In this example, the operator may select an “economic” push level, which may reflect a 50% loaded bucket. For the same project then, the number of cycles may be 10,000 instead of 5000. Moreover, the cycle time per cycle may be slightly longer at 30 seconds considering travel time of the work machine, so the total project time may be 83 hours in lieu of 28. Still further, the pushing level factor may be 0.2 due to the economic push level selected. In this case, since the pushing level is set to economic, the work machine activities are controlled with a focus on maintaining battery life and, as such, charging and recharging activities are performed in the battery's desired operating range. This may be done by setting ceiling values or limits on the voltage and/or current for a main battery bus. Accordingly, very little if any battery damage occurs under the relatively restrictive economic level. In this condition, the pushing level factor of 0.2 can be used without reference to a table as was used with the extreme push level. This pushing level factor may be provided by the manufacturer of the battery and/or may be selected based on testing or historic load/limited use of a battery. Assuming the material factor remains 1.0, the accumulated damage score may be:

$$Accumulated Damage Score = 1. \times 83 \times 0.2 = 16.6 .$$

Given these two comparisons, the operator may consider how much time is available in a contract or a construction schedule, for example, and select a push level that is appropriate to allow for completion of the task while also allowing for preservation of battery life and minimization of battery damage. This may allow for adjusting to weather conditions/delays and other circumstances encountered by the operator. Overall, this may allow an operator or site owner to pursue an economic target by considering the total operation cost of each task. The ability to review an accumulated damage score may allow an operator or site owner to make a strategic decisions about digging while onboard autodig control software performs routine work.

It is to be appreciated that the accumulated damage score may be an adjusted hours calculation and it is noted that while operating under the extreme push level, the accumulated damage is higher than the actual number of operating hours. In contrast, under the economic push level, the accumulated damage is lower than the actual number of operating hours. Moreover, various operating conditions between these push levels may be used. The accumulated damage score may correlate to the actual life of the battery, but this might not be a linear correlation. So, the accumulated damage scores may be primarily used for comparing relative damage amounts for particular projects/conditions. In addition, and secondarily, operators may track the accumulated damage scores over multiple projects and may consider the total accumulated damage when estimating the remaining useful life of the battery. However, this may not be a fully informed or accurate estimate of remaining useful life due to the non-linearity between the accumulated damage scores and the amount of battery life being used up.

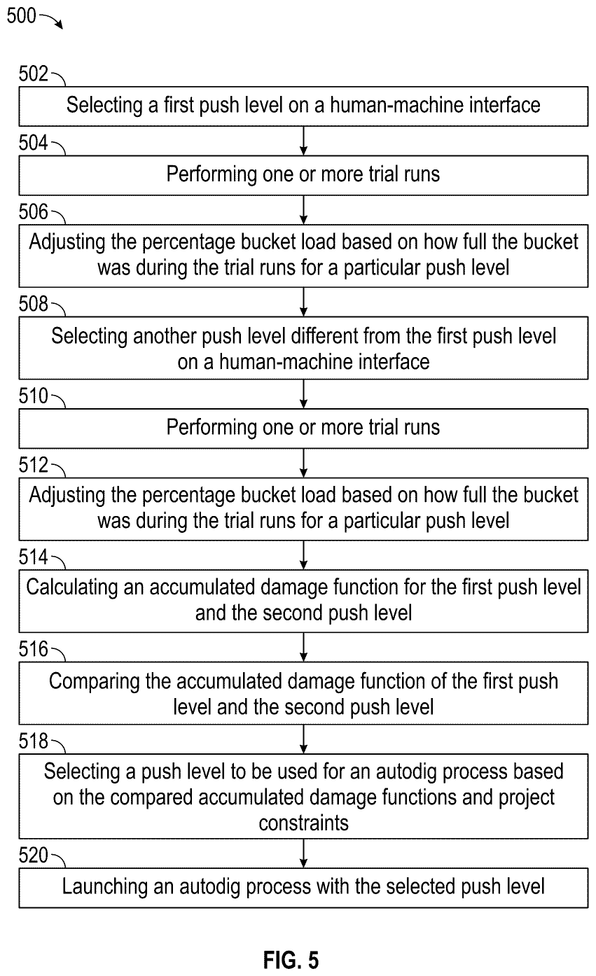

Based on the above and with reference to FIG. 5, a method of operating a work machine may include one or more of the following steps. For example, an operator may select a first push level on a human-machine interface and may operate the work machine to perform one or more trial runs. The operator may adjust the percentage bucket load based on how full the bucket was during the trial runs for a particular push level. The operator may also select another push level different from the first push level on a human-machine interface and may operate the work machine to perform one or more additional trial runs. The operator may also adjust the percentage bucket load based on how full the bucket was during the trial runs for a particular push level. The electronic controller may be used to calculate an accumulated damage function for the first push level and the second push level. The operator may compare the accumulated damage function of the first push level and the second push level and may select a push level to be used for an autodig process based on the compared accumulated damage functions and project constraints. In one or more examples, the operator may launch an autodig process with the selected push level.

While lookup tables have been described for purposes of determining a push level factor and/or a material factor, one or more trial runs may also be used to establish or refine the push level factor and/or the material factor. In some examples, the trial run may be used to establish a combined push level/material factor. That is, where a trial run is performed and the work machine, for example, is used to fill the bucket completely, comparisons may be made between the energy used to dig, lift, swing, dump, and return from delivering a full load to a haul truck, for example. These comparisons may allow for selection of a push level factor and/or a material factor and/or a combined factor because the energy used when the factors in the tables were generated may be known and variations from those values may allow for determination of a factor relevant for the current digging operation.

With respect to the energy used, one or more aspects of the excavator operation may be used in the comparison. For example, the electronic controller 128 can use data and information from the sensors to estimate the power consumption from parameters and values such as the volume or weight of material moved during the work cycle 200, the duration of the work cycle 200, power consumption or ratings about the electrical motors that can be obtained from the motor sensors, the material characteristics of the terrain surface that can be obtained by the material sensors, etc. The estimation may utilize information and data about the motions and applied forces on the booms 108/110, for example as obtained from the rotary encoders and/or pressure sensors, to estimate the energy expended during the work cycle 200. Additional values and information for estimating the power consumed can be stored and retrieved from the power requirements database and the work cycle database. One or a combination of these data points may be compared to a same or similar datapoint associated with a known push level or material factor and used to establish a push level factor or a material factor relevant for the present operation.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A work machine, comprising:
a machine frame supported on a traction system;
an implement supported by the machine frame and operable to perform work;
an electrical power supply system configured for powering the traction system and the implement; and
an electronic controller configured for controlling operation of the work machine and for calculating an accumulated damage score for a plurality of work cycles, the electronic controller comprising a human-machine interface comprising a push level selector allowing an operator to select a push level to be used to perform the plurality of work cycles where the electronic controller is configured to select a factor based on the selected push level to be used to calculate the accumulated damage score.

2. The work machine of claim 1, wherein the implement comprises a boom and a bucket for excavating.

3. The work machine of claim 2, wherein the human-machine interface further comprises a site information interface comprising a plurality of input fields.

4. The work machine of claim 3, wherein the plurality of input fields comprise a site dimension field.

5. The work machine of claim 4, wherein the site dimension field comprises a site area field.

6. The work machine of claim 5, wherein the site dimension field comprises a depth field.

7. The work machine of claim 3, wherein the plurality of input fields comprises a frozen depth field.

8. The work machine of claim 3, wherein the plurality of input fields comprises a material characteristics field.

9. The work machine of claim 1, wherein the accumulated damage score comprises a product of a number of work hours and a push level factor.

10. The work machine of claim 1, wherein the accumulated damage score comprises a product of a material factor, a number of work hours, and a push level factor.

11. A method of operating a work machine, comprising:
selecting a first push level on a human-machine interface;
calculating a first accumulated damage function of a first plurality of work cycles for the first push level;
selecting a second push level on the human-machine interface;
calculating a second accumulated damage function of a second plurality of work cycles for the second push level;
comparing the first accumulated damage function to the second accumulated damage function; and
selecting a push level for a project based on the comparing and based on a project constraint.

12. The method of claim 11, wherein selecting the push level comprises selecting a push level for an autodig process.

13. The method of claim 11, wherein calculating a first accumulated damage function comprises multiplying a number of hours to complete a plurality of work cycles by a push level factor.

14. The method of claim 11, wherein calculating a first accumulated damage function comprises multiplying a number of hours to complete a plurality of work cycles by a push level factor and a material factor.

15. The method of claim 11, wherein project constraints comprise a period of time to complete the project.

16. The method of claim 11, wherein selecting a push level comprises selecting a lowest push level that allows for meeting the project constraint.

17. The method of claim 11, wherein the push level correlates with a percentage of fullness of a bucket.

18. The method of claim 17, further comprising performing a trial work cycle to establish how the push level correlates with the percentage of fullness of the bucket.

19. The method of claim 18, further comprising using the percentage of fullness of the bucket and using site dimensions to determine a number of work cycles to complete the project.

20. The method of claim 19, further comprising multiplying the number of work cycles by a time per work cycle to determine a total project time.
